(19) United States
(12) Patent Application Publication
(10) Pub. No.: US 2026/0361741 A1
(43) Pub. Date: Nov. 12, 2026

(54) SYSTEMS AND METHODS OF NETWORK SECURITY PLAYBOOK CREATION AND UTILIZATION

(71) Applicant: Quiot Security, Portola Valley, CA (US)

(72) Inventors: Ronald Joseph Kent, Keller, TX (US); Michael Reid Tennefoss, Portola Valley, CA (US)

(21) Appl. No.: 19/673,323

(22) Filed: May 11, 2026

Related U.S. Application Data
(60) Provisional application No. 63/804,448, filed on May 12, 2025.

(51) Int. Cl. H04L 9/40

(52) U.S. Cl. CPC H04L 63/1425; H04L 63/1441

(57) ABSTRACT

A method and apparatus of a system that utilizes an anomaly operational maintenance and/or network security playbook is described. In an exemplary embodiment, the system detects an anomaly in a network, wherein the anomaly affects the operational readiness and/or security of a device in the network, and the device is one of a plurality of devices in the network. Furthermore, the system can generate an initial set of operational maintenance and/or network security playbooks using a plurality of Large Language Models (LLMs), wherein a playbook is a set of procedures to mitigate the anomaly. In addition, the system can refine the initial set of operational maintenance and/or network security playbooks using the plurality of LLMs. The system can further cross-evaluate the refined set of operational maintenance and/or security playbooks to generate a final set of operational maintenance and/or network security playbooks. The system can additionally score each of the playbooks in the final set of operational maintenance and/or network security playbooks. In addition, the system can select the anomaly operational maintenance and/or network security playbook using the plurality of scores. The system can further utilize the anomaly operational maintenance and/or network security playbook to trigger, activate, release, or otherwise invoke agentic artificial intelligence (AI) agent(s) to mitigate the anomaly by updating a configuration of one of the plurality of devices in the network.

### CROSS-REFERENCE TO RELATED APPLICATIONS

This application claims the benefit of U.S. Provisional Patent Application No. 63/804,448, filed on May 12, 2025, which application is incorporated herein by reference.

This application is related to the following co-pending application filed on the same day as the present application: U.S. patent application Ser. No. 19/673,512, titled “System And Methods For Threat-Aware Key And Cipher Rotation”, attorney docket no. 198822.00012 (1010US2), which application is incorporated herein by reference.

### FIELD OF INVENTION

This invention relates generally to network security and more particularly to creating operational maintenance and network security playbooks in response to anomaly detection and remediation.

### BACKGROUND OF THE INVENTION

Customers that want to create incident response and vulnerability playbooks describing how to discover and analyze operational maintenance and security incidents, track and coordinate incident responses, and catalog incidents for future reference are faced with a conundrum. Disparate systems require specialized skills to effectively apply operational maintenance and cybersecurity controls and are in short supply. Manual remediation of systems to ensure operational maintenance and cybersecurity compliance is complex and prone to human error, with potentially disastrous consequences if implemented incorrectly. Machine Learning (ML) can be used to standardize processes and procedures based on known guidelines, but only at the risk of not anticipating incidents otherwise unforeseen. Alternatively, Generative Artificial Intelligence (GAI) can be used to analyze past events and create a playbook for them and their derivatives at the risk of incorporating hallucinated or unreliable data.

### SUMMARY OF THE DESCRIPTION

A method and apparatus of a system that creates and utilizes operational maintenance and network security playbooks is described. In an exemplary embodiment, the system detects an anomaly in a network, wherein the anomaly affects the operational readiness and/or security of a device in the network, and the device is one of a plurality of devices in the network. Furthermore, the system can generate an initial set of operational maintenance and network security playbooks using a plurality of Large Language Models (LLMs), wherein a playbook is a set of procedures to mitigate the anomaly. In addition, the system can refine the initial set of operational maintenance and network security playbooks using the plurality of LLMs. The system can further cross-evaluate the refined set of playbooks to generate a final set of operational maintenance and network security playbooks. The system can additionally score each of the playbooks in the final set of operational maintenance and network security playbooks. In addition, the system can select the highest scored operational readiness and network security playbook using the plurality of scores. The system can further utilize the highest scored operational readiness and network security playbook to trigger, activate, release, or otherwise invoke agentic artificial intelligence (AI) agent(s) to mitigate the anomaly/anomalies by updating a configuration of one of the plurality of devices in the network.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is an illustration of one embodiment of a system for operational maintenance and network security playbook creation and/or utilization.

FIG. 2 is a flow diagram of one embodiment of a process for playbook creation.

FIG. 3 is a flow diagram of one embodiment of a process for initial playbook creation.

FIG. 4 is a flow diagram of one embodiment of a process for playbook validation.

FIG. 5 is a flow diagram of one embodiment of a process for playbook consensus and selection.

FIG. 6 is a flow diagram of one embodiment of a process for playbook scoring.

FIG. 7 is a flow diagram of one embodiment of a process for playbook inference.

FIG. 8 is an illustration of one embodiment of a completed playbook.

FIG. 9 illustrates one example of a typical computer system, which may be used in conjunction with the embodiments described herein.

### DETAILED DESCRIPTION

A method and apparatus of a system that creates and utilizes operational maintenance and network security playbooks (hereafter “network security playbooks”) is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a system that creates and utilizes network security playbooks is described. In one embodiment, machine learning (ML) is an application of artificial intelligence (AI) in which mathematical models of data help a computer learn without direct human instruction. ML enables a computer system to continuously learn based on its own experience, and is ideal for recommendation systems, predictive analytics, and diagnostic tools. However, ML is not ideal for applications requiring the generation of new content.

Generative artificial intelligence (GAI) is also an application of artificial intelligence but differs from ML by using generative models to learn the underlying patterns and structures of their training data, using them to create new data based on the input. The creation of new content makes GAI ideal for creative domains, deepfakes, and advanced simulations. However, depending on how it is trained, GAI can hallucinate, lie, or produce inconsistent results in unfamiliar situations, and is not ideal for autonomous operation.

In one embodiment, customers that want to create operational maintenance and cybersecurity incident response and vulnerability playbooks describing how to discover and analyze incidents, track and coordinate incident responses, and catalog incidents for future reference are faced with a conundrum. Disparate systems require specialized skills to effectively apply operational maintenance and cybersecurity controls and are in short supply. Manual remediation of systems to ensure operational maintenance and cybersecurity compliance is complex and prone to human error, with potentially disastrous consequences if implemented incorrectly. ML can be used to standardize processes and procedures based on known guidelines, but only at the risk of not anticipating incidents otherwise unforeseen. Alternatively, GAI can be used to analyze past events and create a playbook for them and their derivatives at the risk of incorporating hallucinated or unreliable data.

Generating remediation playbooks with GAI is known in the art with variances based on the GAI's training inputs, implementation, and output design. In some instances, a second set of LLMs is used to verify the output of an initial set of LLMs. However, simply feeding the output of an LLM into one or more chained LLMs without a consensus or scoring mechanism and system-specific training may not prevent the propagation of misinformation and improper playbook recommendations through the chain. Nor will they prevent cyberattacks from propagating through the LLM chain.

Furthermore, processes that are driven by user inputs or user prompts, or that present LLM results directly to users, risk overwhelming users with storms of data unassociated with site specific information like host names and IP addresses. Eliminating a direct user interface with the LLM via a site-relevant user interface with parsed, organized, serialized data, would eliminate these issues and minimize the chance that an LLM could be jailbroken by a user since direct LLM access would not be provided.

In one embodiment, remediation playbooks can be for any combination of operational device out-of-normal operation or operating system, version, patch level, and cryptographic security vulnerability, and introduce a process of checking the GAI's output by using multiple pre-trained ML models. In one embodiment, the checking of the GAI's output by using multiple pre-trained ML models can be performed concurrently or serially with ensemble and consensus methods acting based on the system architecture in a playbook. Consensus validates GAI outputs and addresses limitations found in any single ML model and makes possible rapid model updates. Given the rapid rate of change in GAIs, witnessed by the speed with which DeepSeek and Grok 3 impacted the field, the ability to quickly add new models with diverse opinion perspectives will accelerate the utility, insights, and robustness of the playbook recommendations. Post-processing using ML models trained on the system architecture ensures that the playbook is specifically applicable to the target architecture and not an artifact carried over from an inapplicable system design.

In one embodiment, ML can be used to put guardrails around GAI-generated customized playbooks that walk customers step-by-step through the remediation process for operational maintenance and cybersecurity vulnerabilities discovered by a GAI+ML process. In one embodiment, the GAI+ML process can be a centralized process for life-cycle management of multiples of devices in a network. In this embodiment, the playbooks can use ML-generated content to train the GAI model and put boundaries around the resulting recommendations. GAI is used in batch processes to automatically generate playbooks, without manual intervention, which are curated by ML algorithms trained on predictive analytics, system vulnerabilities, remediation procedures, and potential compensating controls.

In one embodiment, GAI is further used to parse the final ensemble result achieved via GAI consensus. This GAI process extracts the relevant fields from the finalized playbook and formats it into SQL database commands. These commands are utilized in a later step by a separate non-GAI program to execute these commands, serializing the finalized playbook into the database for storage and subsequent retrieval and synthesis with customer specific data including among others IP addresses, host names, operating systems, software versions, and/or port numbers.

In a further embodiment, the finalized playbook can invoke an agent to execute the playbook in order to remediate the operational maintenance anomaly and/or cybersecurity vulnerability (or anomaly). In this embodiment, completion of the playbook signals to the same or different device that generated the playbook, to invoke an agent to perform the remediation. In one embodiment, the remediation by the agent can be performed by updating a configuration of a device exhibiting or affected by the anomaly, where that device runs using the updated configuration. For example, and in one embodiment, the agent can: terminate or suspend a process, service, or session executing on one of the plurality of devices; quarantine, delete, or encrypt data residing on one of the plurality of affected devices; revoke or rotate a credential, token, or cryptographic key associated with the network; restore one of the plurality of devices to a previously captured state; capture forensic data from one of the plurality of devices; generate and/or execute a multi-step remediation plan composed by an agentic AI across two or more of the plurality of devices; or any other action determined by the agentic AI to mitigate, contain, or remediate the detected anomaly. In one embodiment, the agent is an agentic AI agent (hereafter “AI Agent”). In a further embodiment, the playbook can include an instruction to trigger a rotation of an encryption key and/or algorithm as described in U.S. patent application Ser. No. 19/673,512, entitled “SYSTEM AND METHODS FOR THREAT-AWARE KEY AND CIPHER ROTATION”, filed on May 11, 2026, which is incorporated herein by reference.

This methodology is intended to cull playbook scenarios that have no plausible foundation based on continuously learning the system architecture. Should the GAI system be jailbroken, the background ML system will prevent the implementation of implausible playbook scenarios.

In practice, a system implementing the GAI+ML process for operational technology hosts could work as follows:
1. The GAI+ML process can monitor the network for communications between hosts, using a combination of SSL/TLS inspection to determine encryption algorithm and key length, and entropy analysis to detect weak encryption or plaintext communication.
2. GAI+ML process generates an alert when non-secure communications between two hosts (TLS 1.0, ECC key exchange, and/or another type of non-secure communications) are observed, and an external process (e.g., an external ML process) can classify those devices or uses a connection to Configuration Management Databases (CMDBs) and Governance, Risk, and Compliance (GRC) systems to obtain the device classifications for the two hosts that generated the alert. The user is alerted and provided with recommended remediation steps, e.g., how to enable TLS 1.3 on those hosts.
3. An automated GAI process generates remediation playbooks for the possible combination of hosts (Windows, Linux, Mac, etc.) and the issues that could be encountered (insufficient key length, outdated TLS, etc.). In one embodiment, the playbooks are checked by a query GAI+ML module based on-premises or in a private, public, or government cloud, which is an ensemble of independent and separately trained LLMs, to determine if the recommendations align with the system architecture and devices, recommend high-risk operations, or include fanciful or unrealistic scenarios.

In one embodiment, this ensemble of GAI processes is used in concert with an oversight process that calculates a consensus score for each review of the playbook by each instance of the LLM validation process. If the consensus score is higher than an administrator-defined threshold, the playbook is immediately normalized into a single schema for later transmission and usage by the end customer. If an acceptable GAI+ML process ML consensus score is not reached, the GAI+ML process ML findings are routed for manual inspection and editing by an operational engineering and/or threat intelligence team which approve, deny, or edit the scenario. The playbook is then normalized into a single schema to provide a common format for use by the user.
4. The GAI+ML process ML module user sees the alert, and a recommended set of remediation steps-the playbook-which include a guide showing how to enable TLS 1.3 on the hosts or automatically enabling TLS 1.3 on the hosts.
5. Should the customer encounter an issue that is not in the pre-generated playbooks, an anonymized description of the issue and host classification is sent to the GAI+ML process GAI and the cycle outlined in 1 above is initiated.

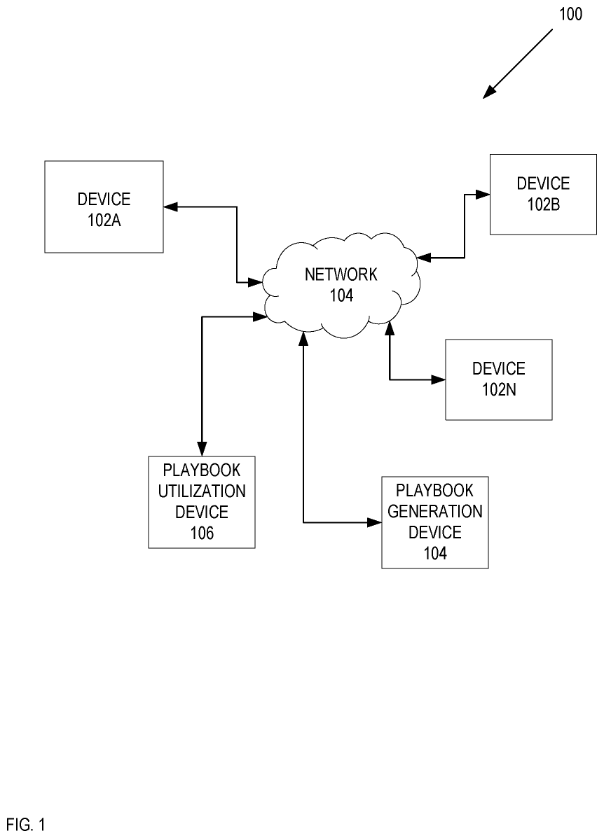

FIG. 1 is an illustration of one embodiment of a system 100 for network security playbook creation and/or utilization. In FIG. 1, the system 100 includes multiple devices 102A-N that communicate with each other through a network 104. In addition, there is a playbook creation device 106 and a playbook utilization device 108. In one embodiment, each of the devices 102A-N, the playbook creation device 106, and/or playbook utilization device 108 can, independently, be any type of device that can support media streaming (e. g., smartphone, laptop, personal computer, server, tablet, wearable, vehicle component, and/or any type of device that can process instructions of an application). In addition, the network 104 can be any type of network that supports media streaming (e.g. Wi-Fi, Cellular, Bluetooth, Ethernet, another type of network, and/or a combination therein).

In one embodiment, in response to an anomaly detected in the operational technology or data network that may or may not affect one or more of the devices 102A-N, the playbook creation device 106 can create a playbook to mitigate or remediate the detected anomaly. In one embodiment, a playbook is series of steps that can be taken to update a configuration or the executing of one of the devices 102A-N. The playbook can be performed manually by a network administrator or can be automatically executed by an invoked agent. In a further embodiment, the playbook utilization device 108 performs an inference part of the GAI, where the anomaly is characterized and the playbook corresponding to that anomaly is presented to the user via a user interface (UI) and/or automatically executed by an agent to perform remediation to the anomaly.

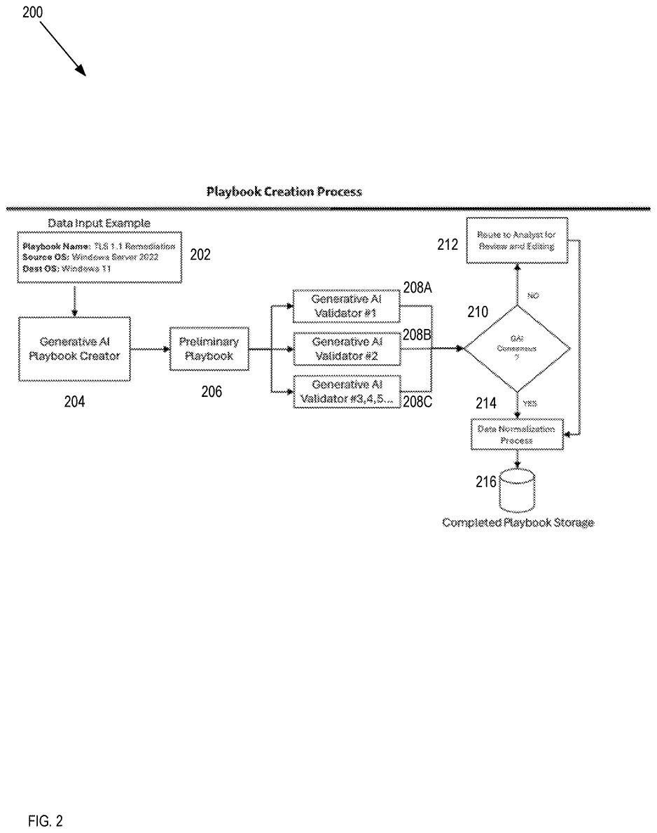

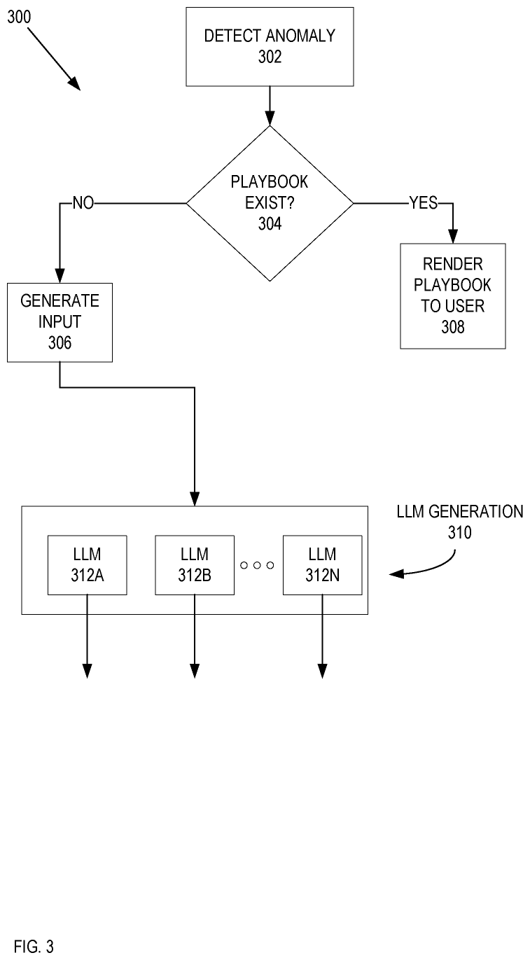

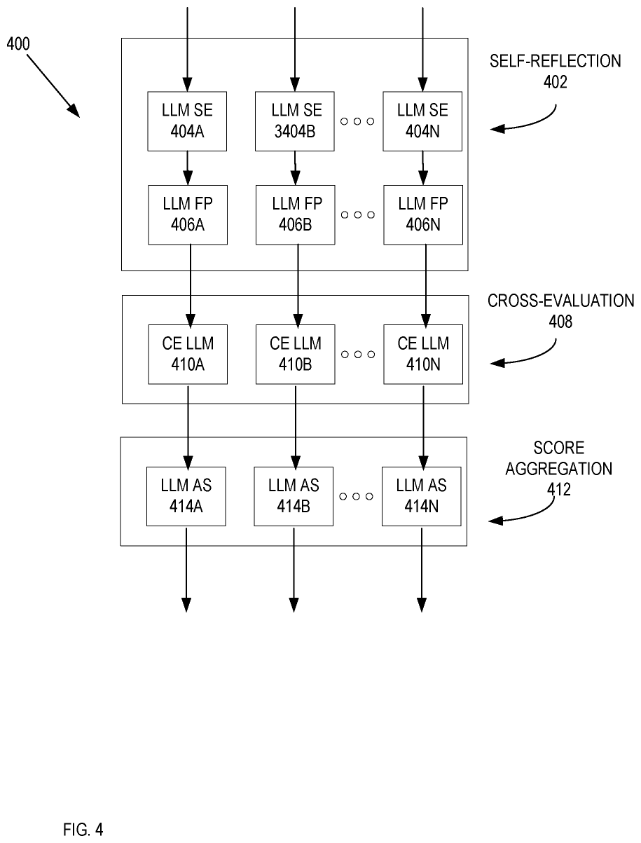

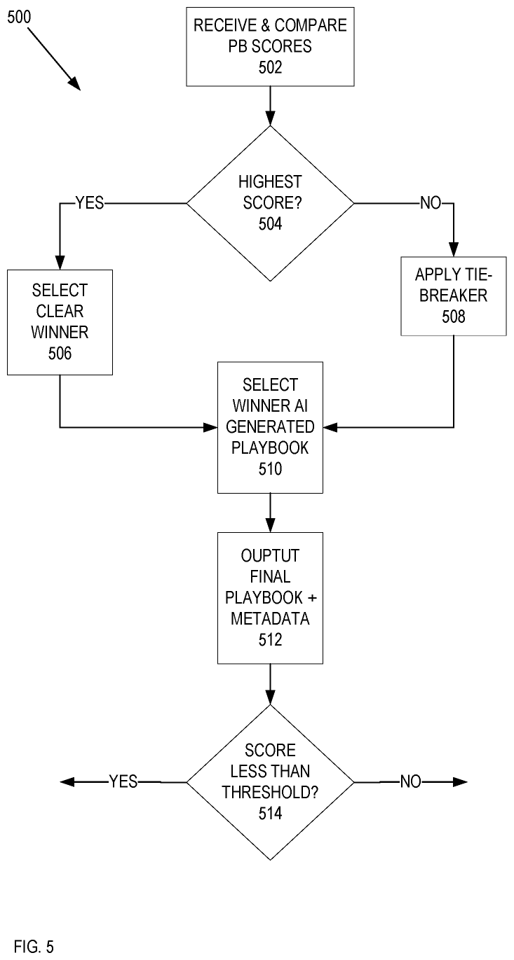

FIG. 2 is a flow diagram of one embodiment of a process 200 for playbook creation. In FIG. 2, process 200 begins by retrieving the data input at block 202. For example, and in one embodiment, the playbook name can be TLS 1.1 remediation, the source OS is a Windows Server 2022 and the destination OS is windows 11. At block 204, process 200 performs the generative AI playbook creator, which results in a preliminary playbook at block 206. Playbook creation is further described in FIG. 4 below. At blocks 208A-C, process 200 performs multiple generative AI validators. In one embodiment, each of the generative AI validators (blocks 208A-C) is a ML validator as described above. While in one embodiment, three generative AI validators are illustrated, in alternative embodiments, there can be more or less numbers of generative AI validators. Playbook validation is further described in FIG. 5 below. At block 210, process 200 determines if a GAI consensus is reached. Playbook consensus and selection is further described in FIG. 3 below. If not, execution proceeds to block 212 where process 200 routes the results to an analyst for review and editing. Execution proceeds to block 214 below. If, at block 210, a GAI consensus was reached, execution proceeds to block 214 where process 200 performs a data normalization process. At block 216, process 200 stores a completed playbook in persistent storage.

FIG. 3 is a flow diagram of one embodiment of a process 300 for initial playbook creation. In one embodiment, process 300 is performed by a process to initially create a playbook, such as process 200 as described in FIG. 2, block 204 above. In FIG. 3, process 300 begins by detecting an anomaly in the network at block 302. In one embodiment, an anomaly in a network security sense is a deviation from an established baseline of normal behavior that may indicate malicious activity, policy violations, or operational issues. In one embodiment, the anomaly can be detected by cybersecurity device(s) and/or process(es), where the cybersecurity device or process can communicate to process 300 the existence and/or characteristic(s) of the anomaly. For example, and in one embodiment, the anomaly can be an alert information such as a sensor reading that is 15 mA when a historical baseline for this sensor showed a range from 4-10 mA. At block 304, process 300 determines if a playbook exists for this anomaly. If the playbooks exist, execution proceeds to block 308 below.

If the playbook does not exist for the detected anomaly, process 300 generates input at block 306. In one embodiment, process 300 generates input for the playbook creation using the different Large Language Models (LLMs). For example, and in one embodiment, process 300 can create prompts for the different LLMs that are going to be used for playbook creation. In this example, and embodiment, process 300 can use the same or different prompts for the various LLMs used in the initial playbook creation. If the anomaly is TLS 1.1 remediation, where the source OS is a Windows Server 2022 and the destination OS is Windows 11, the prompt can be: “what is a remediation for TLS 1.1 when the source OS is a Windows Server 2022 and the destination OS is a Windows 11.” In a further example and embodiment, the prompt can include contextual information. In the sensor example above, the contextual information can be a make and model of sensor, previous alerts, any concurrent alerts from the same sensor, third-party alerts on the connected controller, and/or any related RAG information (e.g., product manuals, security operations response procedures, troubleshooting guides, and/or any other RAG information) can be used for the input generation.

At block 310, process 300 selects the multiple LLMs 312A-N that are used to handle the playbook generation. In one embodiment, process 300 performs an initial generation of the playbook using the different LLMs. In one embodiment, the LLMs used by process 500 can be determined by the customer and are swappable at runtime. The customer can use a combination of publicly available models (e.g., Claude, ChatGPT, Gemini, Grok, and/or other types of publicly available LLMs), local models, or custom trained models. These LLMs can be augmented by customer-provided documentation that has specifics on their policies and procedures, system documentation, and other useful sources of customer-specific information. In this embodiment, the choice of LLM is agnostic to process 300. This set of LLMs is then used to create the initial playbook.

In one embodiment, process 300 generates an initial playbook for each of the LLMs that can be validated by a self-evaluation stage and a cross-evaluation stage. In this embodiment, the LLM that was used to generate the initial playbook can perform one or more self-evaluation cycles that are used to reduce hallucinations and improve accuracy. A cross-evaluation stage uses a different LLM to evaluate a playbook that has been refined by the self-evaluation stage. FIG. 4 is a flow diagram of one embodiment of a process 400 for playbook validation. In one embodiment, process 400 is performed by a process to initially create a playbook, such as process 200 as described in FIG. 2, blocks 208A-C above. In FIG. 4, process 400 begins by receiving the initial playbooks generated by process 300 above and performing self-reflection (404A-N) using the LLMs on the initial playbooks at block 402. In one embodiment, LLM self-reflection is when a model pauses after producing an answer, analyzes its own reasoning or result, identifies possible errors or gaps, and then improves the answer. In one embodiment, process 400 performs the self-reflection X times (404A-N) (two, three, or more times). In another embodiment, process 400 performs the self-reflection for the same or a different number of times for the different LLMs. Process 400 outputs the final playbooks (406A-N) at block 402.

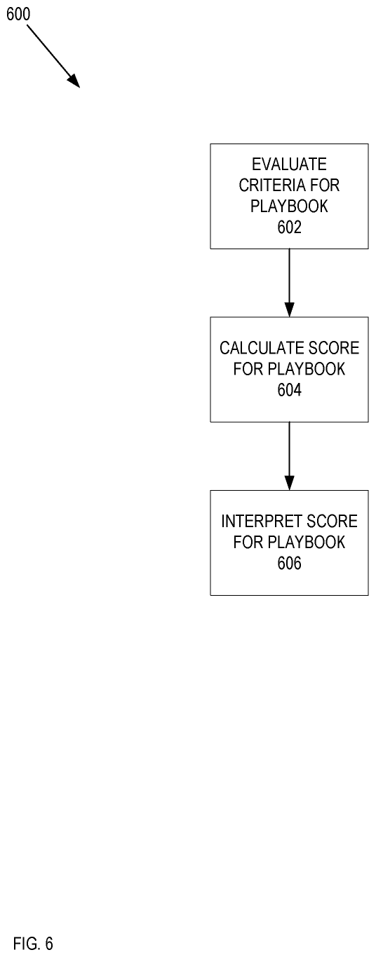

At block 408, process 400 cross-evaluates the final playbooks. In one embodiment, process 400 cross-evaluates the final playbooks by using a different one or more LLMs to evaluate the final playbook generated by a particular LLM. For example, and in one embodiment, for a final playbook LLM #3, process 400 uses a different LLM to cross-evaluate that final playbook. In one embodiment, process 400 can use each LLM to rank the other playbooks based on specific scoring criteria and then the overall scores are compared. Process 400 score aggregates each of the final playbook at block 412. In one embodiment, process 400 generates a score for each of the playbooks. Scoring the final playbooks is further described in FIG. 6 below.

FIG. 5 is a flow diagram of one embodiment of a process 500 for playbook consensus and selection. In one embodiment, process 500 is performed by a process to determine a playbook consensus and selection, such as process 200 as described in FIG. 2, block 210 above. In FIG. 5, process 500 begins by receiving and comparing the LLM playbook scores at block 502. In one embodiment, process 500 scores each of the final playbooks by evaluating different criteria for each of the final playbooks and calculating a score using the evaluated criteria. Calculating the playbook scores is further described in FIG. 6 below.

At block 504, process 500 determines if one of the final playbooks has the highest score. If so, process 500 selects a clear winning playbook at block 506. Execution proceeds to block 510 below. If there is not final playbook with the highest score (e.g., there is a tie among two or more final playbooks), process 500 applies a tiebreaker to determine a winning playbook. In one embodiment, the tiebreaker can be which playbook has the fastest generation, uses the least resources, and/or another type of metric. Execution proceeds to block 510 below.

At block 510, process 500 selects the winning AI generated playbook. Process 500 outputs the winning final playbook along with the associated metadata at block 512. In one embodiment, the metadata can be context around the devices involved in the playbook, data obtained via retrieval automated generation (RAG) processes of customer information (policies, procedures, and/or other types of information), and/or other types of metadata associated with the playbook.

At block 514, process 500 determines if the score of the winning playbook is less than a threshold. In one embodiment, the threshold can be 70 on a scale of 0 -100 (or can be some other threshold value using the same or different scale). If so, process 500 returns a yes. If the score is greater than or equal to the threshold, process 500 returns a no.

FIG. 6 is a flow diagram of one embodiment of a process 600 for playbook scoring. In one embodiment, process 600 is performed by a process to determine a playbook scoring, such as process 500 as described in FIG. 5, block 502 above. In FIG. 6, process 600 begins by evaluating criteria for the LLM playbook at block 602. While in one embodiment, process 600 can evaluate the playbook for the criteria of relevance, coherence, and factual accuracy, in alternate embodiments, process 600 uses a subset of these criteria, additional criteria, and/or a combination therein. In one embodiment, relevance is whether the playbook addresses the alert or anomaly. Furthermore, the coherence criteria evaluates whether the playbook is logically structured. In addition, the factual accuracy criteria evaluate the playbook as to whether the playbook is technically accurate. At block 606, process 600 interprets the score of the playbook. In one embodiment, process 600 interprets the playbook score to determine the relative strength of the playbook. For example, and in one embodiment, using a scoring scale of 1-100 and a threshold of 70, a playbook score of 90-100 could be considered excellent, a playbook score of 70-89 could be considered good, a playbook score of 50-69 could be considered needing improvement, and a playbook score below 50 could be considered poor.

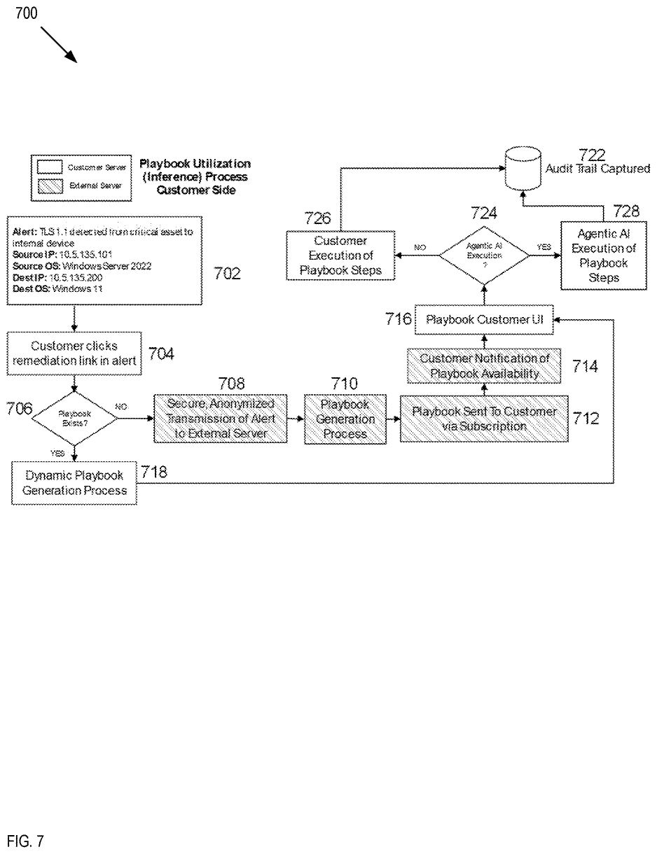

With a playbook created, the playbook can be used for runtime inference. FIG. 7 is a flow diagram of one embodiment of a process 700 for runtime inference. In FIG. 7, process 700 begins by receiving the input data. For example, and in one embodiment, the input data can be an alert that TLS 1.1 is detected from a critical asset to an internal device, where the source IP is 10.5.135.101, the source OS is Windows Server 2022, the destination IP is 10.5.135.200, and the destination OS is windows 11 at block 702. At block 704, process 700 detects that a customer has clicked the remediation link in the alert. Process 700 determines if the playbook exists at block 706. If the playbook exists, at block 718, process 700 performs a dynamic playbook generation process. In one embodiment, process 700 assumes that the structure, steps, and related processes have already been completed, and customer data are populated into the structure. At block 716, process 700 displays a playbook customer UI of the results. A decision process 724 is then presented to the user, or automatically chosen via policy, where some or all of the steps inside of the playbook can be executed autonomously by an AI Agent. If the user elects to execute the playbook steps manually at 724, block 726 is executed where the user is guided step-by-step through the remediation process. If the user elects to utilize Agentic AI at 724, process 728 is executed where an AI Agent will autonomously execute some or all of the playbook steps. The audit trail is captured and stored at block 722 if either block 726 or 728 is executed, ensuring that manual execution and autonomous execution data are both captured for auditing, reporting, and troubleshooting purposes among others.

If the playbook does not exist, at block 708, process 700 performs a secure and anonymized transmission of the alert to a secure evaluation service. At block 710, process 700 performs a playbook generation process. In one embodiment, process 700 generates the structure of the playbook, steps necessary to implement the structure of the playbook and compensating controls, minus any customer information. Process 700 sends the newly generated playbook to a customer electronically via subscription at block 712. At block 714, process 700 notifies the customer of the playbook availability, where process 700 displays the playbook customer UI at block 716. A decision process 724 is then presented to the user, or automatically chosen via policy, where some or all of the steps inside of the playbook can be executed autonomously by an AI Agent. If the user selects to execute the playbook steps manually at 724, block 726 is executed where the user is guided step-by-step through the remediation process. If the user elects to utilize Agentic AI at 724, process 728 is executed where an AI Agent will autonomously execute some or all of the playbook steps. The audit trail is captured and stored at block 722 if either block 726 or 728 is executed, ensuring that manual execution and autonomous execution data are both captured for auditing, reporting, and troubleshooting purposes among others.

In one embodiment, block 708, 710, 712 and 714 can be performed by a secure service, where blocks 702, 704, 706, 716, 718,, 722, 724, 726 and 728 can be performed by another server, such as a customer server.

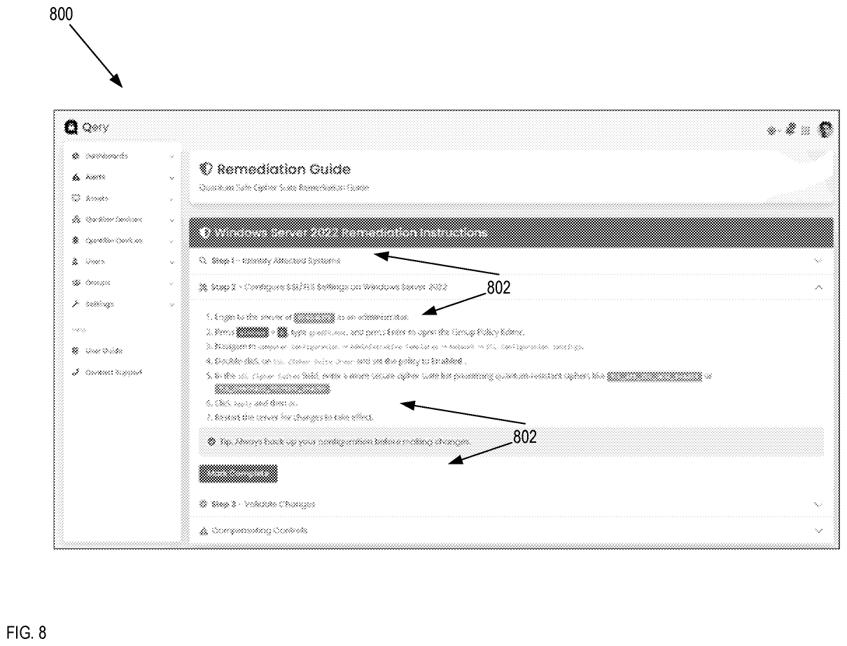

In one embodiment, process 700 can create a completed playbook. FIG. 8 is an illustration of one embodiment of a completed playbook 800. In FIG. 8, the completed playbook lists a series of steps to remediate (or mitigate) the anomaly. In one embodiment, the anomaly is not being able to use TLS between the Windows Server 2022 and a Windows 11 client. A series of steps 802 are listed that can be performed manually or automatically using an automated agent (e.g., AI Agent).

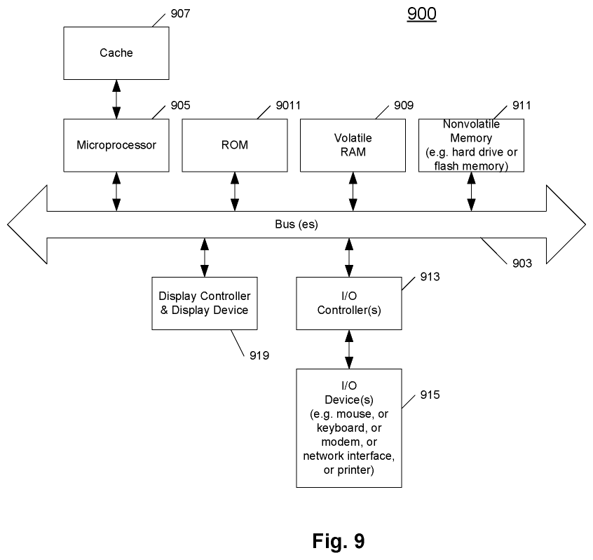

FIG. 9 shows one example of a data processing system 900, which may be used with one embodiment of the present invention. For example, the system 900 may be implemented as a system that includes device 102A as illustrated in FIG. 1 above. Note that while FIG. 9 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 9, the computer system 900, which is a form of a data processing system, includes a bus 903 which is coupled to a microprocessor(s) 905 and a ROM (Read Only Memory) 901 and volatile RAM 909 and a non-volatile memory 911. The microprocessor 905 may include one or more CPU(s), GPU(s), a specialized processor, and/or a combination thereof. The microprocessor 905 may retrieve the instructions from the memories 907, 909, 911 and execute the instructions to perform operations described above. The bus 903 interconnects these various components together and also interconnects these components 905, 907, 909, and 911 to a display controller and display device 919 and to peripheral devices such as input/output (I/O) devices which may be mice, keyboards, modems, network interfaces, printers and other devices which are well known in the art. Typically, the input/output devices 915 are coupled to the system through input/output controllers 913. The volatile RAM (Random Access Memory) 909 is typically implemented as dynamic RAM (DRAM), which requires power continually in order to refresh or maintain the data in the memory.

The mass storage 911 is typically a magnetic hard drive or a magnetic optical drive or an optical drive or a DVD RAM or a flash memory or other types of memory systems, which maintain data (e.g., large amounts of data) even after power is removed from the system.

Typically, the mass storage 911 will also be a random access memory although this is not required. While FIG. 9 shows that the mass storage 911 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting,” “determining,” “generating,” “refining,” “communicating,” “sending,” “receiving,” “cross-evaluating,” “scoring,” “selecting,” “utilizing,” “applying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to utilize an anomaly operational maintenance or network security playbook, the method comprising:
detecting an anomaly in a system or network, wherein the anomaly affects the operational readiness or security of a device in the network, and the device is one of a plurality of devices in the network;
generating an initial set of operational readiness and/or network security playbooks using a plurality of Large Language Models (LLMs), wherein a playbook is a set of procedures to mitigate the anomaly;
refining the initial set of operational maintenance and/or network security playbooks using the plurality of LLMs;
cross-evaluating the refined set of operational maintenance and/or security playbooks to generate a final set of operational maintenance and/or network security playbooks;
scoring each of the playbooks in the final set of operational maintenance and/or network security playbooks;
selecting the anomaly operational maintenance and/or network security playbook using the plurality of scores; and
utilizing the anomaly operational maintenance and/or network security playbook to trigger, activate, release, or otherwise invoke agentic artificial intelligence (AI) agent(s) to mitigate the anomaly by updating a configuration of one of the plurality of devices in the network.

2. The non-transitory machine-readable medium of claim 1, wherein the cross-evaluating comprises:
applying a second LLM to a refined playbook that was refined by a first LLM.

3. The non-transitory machine-readable medium of claim 1, wherein the refining the initial set of playbooks comprises:
for each playbook in the initial set of operational maintenance and/or network security playbooks,
applying an LLM to that playbook a plurality of times.

4. The non-transitory machine-readable medium of claim 3, wherein a different LLM is used to refine different ones of the initial set of operational maintenance and/or network security playbooks.

5. The non-transitory machine-readable medium of claim 1, wherein the scoring is performed using one or more components of relevance, coherence, and factual accuracy.

6. The non-transitory machine-readable medium of claim 5, wherein the factual accuracy component is weighted heavier than either the relevance component or the coherence component.

7. The non-transitory machine-readable medium of claim 5, wherein relevance is whether the playbook addresses the anomaly, coherence is whether the playbook is logically structured, and factual accuracy is whether the playbook is technically correct.

8. The non-transitory machine-readable medium of claim 1, wherein the agent is an agentic AI agent.

9. The non-transitory machine-readable medium of claim 1, wherein the agent can perform one or more of the following actions: terminate or suspend a process, service, or session executing on one of the plurality of devices; quarantine, delete, or encrypt data residing on one of the plurality of affected devices; revoke or rotate a credential, token, or cryptographic key associated with the network; restore one of the plurality of devices to a previously captured state; capture forensic data from one of the plurality of devices; generate and/or execute a multi-step remediation plan composed by an agentic AI across two or more of the plurality of devices.

10. The non-transitory machine-readable medium of claim 1, wherein the selecting comprises:
selecting the playbooks in the final set of operational maintenance and/or network security playbooks with the highest score.

11. A method to utilize an anomaly operational maintenance or network security playbook, the method comprising:
detecting an anomaly in a system or network, wherein the anomaly affects the operational readiness or security of a device in the network, and the device is one of a plurality of devices in the network;
generating an initial set of operational readiness and/or network security playbooks using a plurality of Large Language Models (LLMs), wherein a playbook is a set of procedures to mitigate the anomaly;
refining the initial set of operational maintenance and/or network security playbooks using the plurality of LLMs;
cross-evaluating the refined set of operational maintenance and/or security playbooks to generate a final set of operational maintenance and/or network security playbooks;
scoring each of the playbooks in the final set of operational maintenance and/or network security playbooks;
selecting the anomaly operational maintenance and/or network security playbook using the plurality of scores; and
utilizing the anomaly operational maintenance and/or network security playbook to trigger, activate, release, or otherwise invoke agentic artificial intelligence (AI) agent(s) to mitigate the anomaly by updating a configuration of one of the plurality of devices in the network.

12. The method of claim 11, wherein the cross-evaluating comprises:
applying a second LLM to a refined playbook that was refined by a first LLM.

13. The method of claim 11, wherein the refining the initial set of playbooks comprises:
for each playbook in the initial set of operational maintenance and/or network security playbooks,
applying an LLM to that playbook a plurality of times.

14. The method of claim 13, wherein a different LLM is used to refine different ones of the initial set of operational maintenance and/or network security playbooks.

15. The method of claim 11, wherein the scoring is performed using one or more components of relevance, coherence, and factual accuracy.

16. The method of claim 15, wherein the factual accuracy component is weighted heavier than either the relevance component or the coherence component.

17. The method of claim 15, wherein relevance is whether the playbook addresses the anomaly, coherence is whether the playbook is logically structured, and factual accuracy is whether the playbook is technically correct.

18. The method of claim 11, wherein the agent is an agentic AI agent.

19. The method of claim 11, wherein the agent can perform one or more of the following actions: terminate or suspend a process, service, or session executing on one of the plurality of devices; quarantine, delete, or encrypt data residing on one of the plurality of affected devices; revoke or rotate a credential, token, or cryptographic key associated with the network; restore one of the plurality of devices to a previously captured state; capture forensic data from one of the plurality of devices; generate and/or execute a multi-step remediation plan composed by an agentic AI across two or more of the plurality of devices.

20. The method of claim 11, wherein the selecting comprises:
selecting the playbooks in the final set of operational maintenance and/or network security playbooks with the highest score.
